(19) United States
(12) Patent Application Publication
(10) Pub. No.: US 2009/0289858 A1
(43) Pub. Date: Nov. 26, 2009

(54) ANTENNA DEVICE , A PORTABLE RADIO COMMUNICATION DEVICE COMPRISING SUCH ANTENNA DEVICE, AND A BATTERY PACKAGE FOR A PORTABLE RADIO COMMUNICATION DEVICE

(75) Inventor: Rikard Olsson, Stockholm (SE)

Correspondence Address: HOLLAND & HART, LLP, P.O BOX 8749, DENVER, CO, 80201, US

(73) Assignee: Laird Technologies AB, Akersberga (SE)

(21) Appl. No.: 12/278,248

(22) PCT Filed: Feb. 19, 2007
(86) PCT No.: PCT/SE07/00147

§ 371 Date: Nov. 26, 2008

(30) Foreign Application Priority Data
Feb. 24, 2006 (SE) 0600417-0

(51) Int. Cl. H01Q 1/38; H01Q 1/24; H01Q 13/10

(52) U.S. Cl. 343/702; 343/700 MS; 343/767

(57) ABSTRACT

An antenna device for use in a portable radio communication device comprises a ground plane (110), a microstrip line (114) connected to a feed point (116) for feeding and/or receiving radio frequency signals. A package (120) having an electrically conductive housing (122) is provided in the radio communication device, wherein the housing is provided above the ground plane and the microstrip line, wherein the housing is galvanically insulated from the microstrip line, and wherein the housing is capacitively coupled to the microstrip line. The antenna device thus has a large radiating area and thus providing better performance of the device. Also, an already existing part in the radio communication device, e.g., a battery package, can be used also as radiating element, saving space and costs.

### FIELD OF INVENTION

The present invention relates generally to internal antenna devices and more particularly to an antenna device using a package, such as a battery package, as part of the antenna device. The invention also relates to portable radio communication device comprising an antenna device and a battery package for a portable radio communication device.

### BACKGROUND

Portable communication devices, such as mobile phones and GPS devices are becoming increasingly common among people all around the world. These devices are provided with an internal or external antenna for cellular or GPS applications. However, there is an increasing demand for smaller devices and added functionality and many new mobile phones are therefore provided with a complementary internal antenna supplementing the cellular antenna.

The radiating element of an internal antenna of a portable radio communication device, such as a cellular phone, which is normally positioned at the back of the housing, is preferably made as large as possible since an increased antenna volume results in improved performance. However, a battery package containing a battery powering the communication device is also normally positioned at the back of the housing of the communication device. As with the antenna, a larger battery package results in a battery with better performance, i.e., the battery requires less frequent recharging.

The battery package and an internal antenna device thus compete for the space at the back of the communication device and there has therefore been a trade-off between antenna space and battery space.

Most batteries have a metal casing that may carry currents. The casing is typically a rectangular box and may thus have a general shape corresponding to a patch antenna and can thus be used as such a patch antenna in many different patch configurations.

### SUMMARY OF THE INVENTION

An object of the present invention is to provide an antenna device for portable communication devices, such as mobile phones, wherein the antenna device can be provided without taking too much space from existing components.

Another object is to provide an antenna device enabling the use of larger battery packages.

Another object of the present invention is to provide a combination of antenna and battery device that is more inexpensive than prior art devices.

The invention is based on the realization that many prior art components of a portable radio communication device, such as batteries, displays, and covers, have a shape suitable for use as part of an internal antenna element of a portable communication device.

According to the present invention there is provided an antenna device as defined in appended claim 1.

There is also provided a portable radio communication device as defined in appended claim 12.

There is also provided a battery package for a portable radio communication device comprising an antenna device as defined in appended claim 13.

With the inventive antenna device the above mentioned drawbacks of prior art are eliminated or at least mitigated. The antenna device as defined by the appended claims has a larger radiating area as compared with prior art antennas thus providing better performance of the device. Also, an already existing part in the radio communication device, for example a battery package, can be used also as radiating element, saving space and costs.

In a preferred embodiment, an electrically conductive slotted patch is provided between the ground plane and the package. This provides for easy tuning and widened bandwidth.

Further preferred embodiments are defined in the appended dependent claims.

### BRIEF DESCRIPTION OF DRAWINGS

The invention is now described, by way of example, with reference to the accompanying drawing, in which:

FIG. 1 is an overview of a mobile phone provided with an antenna device according to a first embodiment of the invention;

FIG. 2 is an overview of a mobile phone provided with an antenna device according to a second embodiment of the invention;

FIG. 3 is an detailed view of the antenna device shown in FIG. 2;

FIG. 4 is a view of a slotted patch comprised in the antenna device shown in FIG. 2;

FIG. 4a is a view showing the relationship between the slot of the slotted patch and a microstrip line;

FIGS. 5 and 6 are diagrams showing total efficiency and radiation efficiency, respectively, of an antenna device according to the invention;

FIG. 7 is a diagram showing return loss of an antenna device according to the invention;

FIGS. 8 and 9 are diagrams showing the effect of tuning by means of adjustment of slot length and relative permittivity, respectively;

FIGS. 10 and 11 are diagrams showing the effect of tuning by means of adjustment of length and width, respectively, of a battery package comprised in the antenna device according to the invention;

FIGS. 12 and 13 show alternative slot configurations of the slotted patch comprised in the antenna device according to the invention; and

FIG. 14 shows an alternative embodiment wherein a display is used as part of an antenna.

### DETAILED DESCRIPTION OF PREFERRED EMBODIMENTS

In the following, a detailed description of various embodiments of an antenna device according to the invention will be given. In the description, for purposes of explanation and not limitation, specific details are set forth, such as particular hardware, applications, techniques, etc. in order to provide a thorough understanding of the present invention. However, it will be apparent to one skilled in the art that the present invention may be utilized in other embodiments that depart from these specific details. In other instances, detailed descriptions of well-known methods and apparatuses are omitted so as not to obscure the description of the present invention with unnecessary details.

Also, references are made to different directions, such as “upper” and “lower”. Such references refer to what is shown in the respective figures.

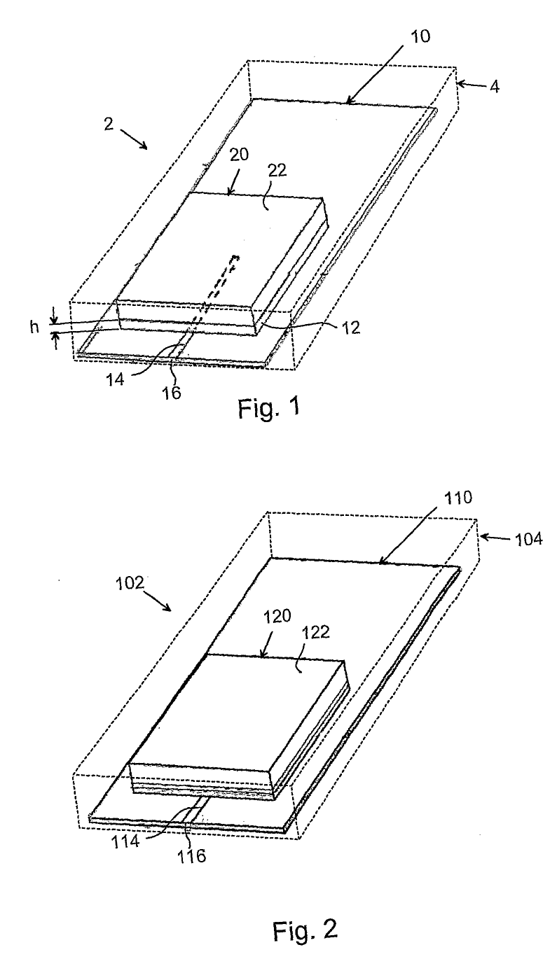

A first embodiment of an antenna device according to the invention will now be described with reference to FIG. 1. A portable radio communication device, such as a cellular phone, generally designated 2, comprises a communication device housing 4 having the features normally found in such a device, such as a display and a keypad (not shown).

The housing 4 encloses a generally planar printed circuit board or PCB 10 having electronic circuits mounted thereon for the functioning of the radio communication device. These electronic circuits also comprise RF electronics for feeding an antenna radiating element functioning for transmitting and receiving electromagnetic RF waves. Furthermore, the PCB functions as a ground plane for the antenna device of the radio communication device.

A battery package, generally designated 20, is provided above the PCB 10. The battery package comprises a battery housing 22 made of metal or other electrically conducting material.

A spacer 12 having a height h is provided between the battery housing and the PCB. This spacer comprises dielectrical material, such as plastic or air. The electrically conductive battery housing is thus provided at a distance h above the PCB.

A microstrip line 14 made of an electrically conductive material is provided on the PCB 10 and connected to a feeding point 16 for feeding and receiving RF signals. This feeding point is connected to the above mentioned RF electronics provided in the radio communication device. The microstrip line 14 is provided under the battery housing 22 so as to achieve capacitive coupling there between.

The dielectric spacer 12 prevents any galvanic contact between the PCB and/or microstrip line and the battery housing. By the provision of the microstrip line 14 in capacitive coupling with the electrically conductive battery housing 22, currents are induced in the battery housing when the microstrip line is fed and vice versa. Thus, the battery housing is comprised in the antenna device also including the microstrip line.

In operation mode, when a user positions the radio communication device adjacent to the head, the battery package faces away from the user, which from a radiation standpoint is preferred.

Many conventional prior art battery packages have lengths and widths such that the battery housing exhibits a resonance frequency suitable for operation in commonly used frequency bands, such as the Bluetooth (2400-2484 MHz), WLAN (2400-2480 MHz), and GPS (1575 MHz) bands.

Tuning of the antenna device shown in FIG. 1 can be accomplished e.g. by changing the position of the microstrip line 14, by adjusting the permittivity of the dielectric spacer 12, or by adjusting the distance h between the microstrip line and the battery housing.

A second embodiment of an antenna device according to the invention will now be described with reference to FIGS. 2-11. This embodiment is to its general configuration similar to the embodiment shown in FIG. 1. Thus, a mobile phone, generally designated 102, comprises a housing 104 having the features normally found in a mobile phone, such as a display and a keypad (not shown).

The housing 104 encloses a generally planar printed circuit board or PCB 110 having electronic circuits mounted thereon for the functioning of the device. These electronic circuits also comprise RF electronics for feeding an antenna radiating element functioning for transmitting and receiving electromagnetic RF waves.

A microstrip line 114 made of an electrically conductive material is provided on the PCB 110 and is connected to a feeding point 116 for feeding and receiving RF signals.

A battery package, generally designated 120, is provided above the PCB 110. The battery package comprises a battery housing 122 made of metal, such as aluminum, or other electrically conducting material.

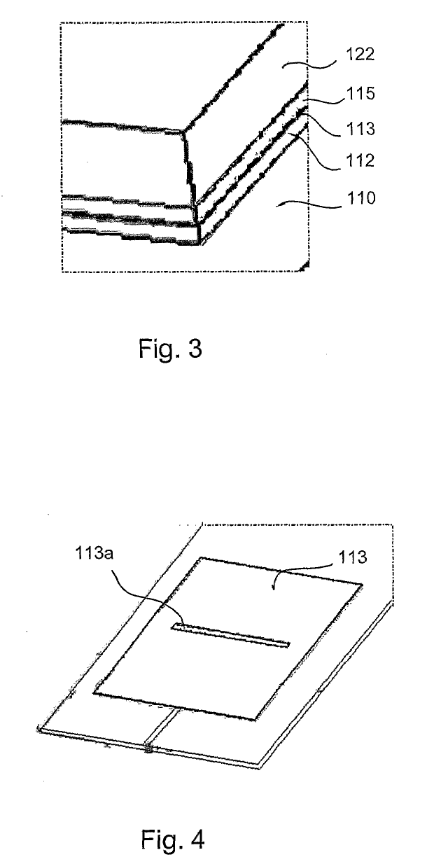

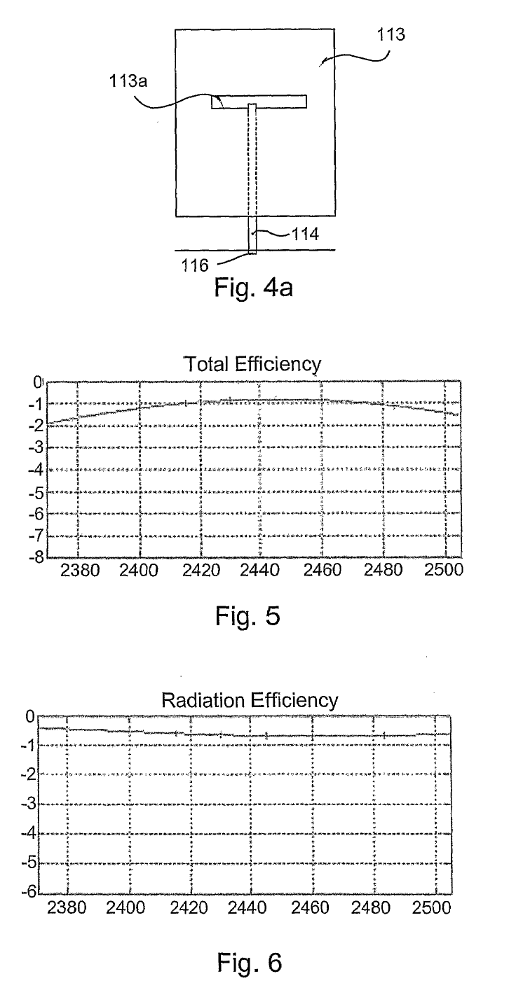

The spacer in the first embodiment has in this second embodiment been replaced by three layers, see FIG. 3. Like in the first embodiment, a first dielectric layer 112 is provided on the PCB in order to avoid any galvanic coupling between the PCB and the battery housing. On top of the first dielectric layer 112 there is provided a slotted patch 113 made of some suitable electrically conductive material, such as copper. An opening in the shape of a slot 113a is provided in the patch 113, see FIG. 4. This slot is elongated having a length to width ratio of at least 3:1, more preferably at least 5:1, even more preferably at least 10:1, and most preferably at least 20:1.

Between the slotted patch 113 and the battery housing 122 there is provided a second dielectric layer 115 ensuring that no galvanic contact exists between the slotted patch 113 and the battery housing 122.

The mutual position of the slot 113a and the microstrip line 114 is shown in FIG. 4a. The microstrip line runs essentially perpendicularly to the extension of the slot 113a and end in a point under the slot. This means that the slot is excited by the open end of the microstrip line that ends just beneath the slot, below the first dielectric layer 112. The slot 113a in turn excites the electrically conductive battery housing 122, which thus functions as a radiating element of the antenna device. In this way, the slotted patch and the electrically conductive battery housing together form a stacked patch configuration.

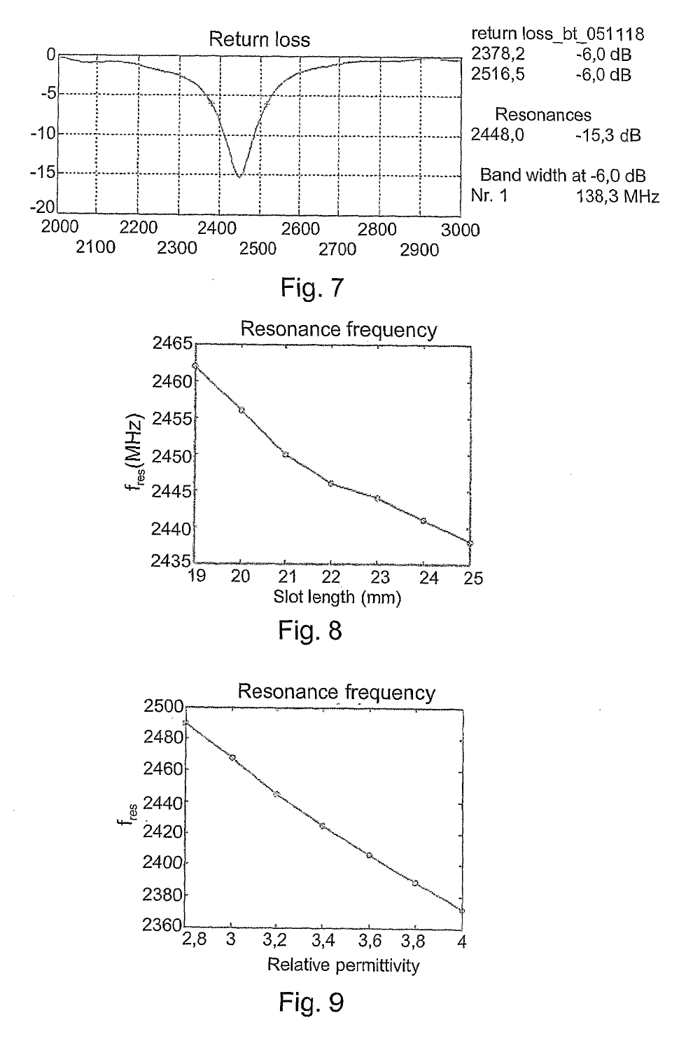

Examples of total efficiency and radiation efficiency in the Bluetooth frequency band are given in FIGS. 5 and 6, respectively. It is evident from these diagrams that the efficiency of the antenna device is more than satisfying. Also the return loss in this frequency band is satisfying, which is evident from FIG. 7.

An advantage of the antenna device according to the invention is that an already existing part in the radio communication device, i.e., the battery package, can be used also as radiating element, saving space and costs. Also, the antenna device shown in FIGS. 2-4 is easy to tune, which will be described in the following with reference to FIGS. 8-11.

One way of tuning the antenna device is to adjust the length of the slot 113. In the diagram shown in FIG. 8, the resonance frequency of the antenna device is given for slot lengths of between 19 and 25 millimeters, wherein the slot width is 2 millimeters.

Another way of tuning the antenna device is to adjust the relative permittivity of the first and second dielectric layers 112, 115. In the diagram shown in FIG. 9, the resonance frequency of the antenna device is given for a relative permittivity of the dielectric material of between 2.8 and 4.0, wherein each of the dielectric layers has a thickness of 1 millimeter.

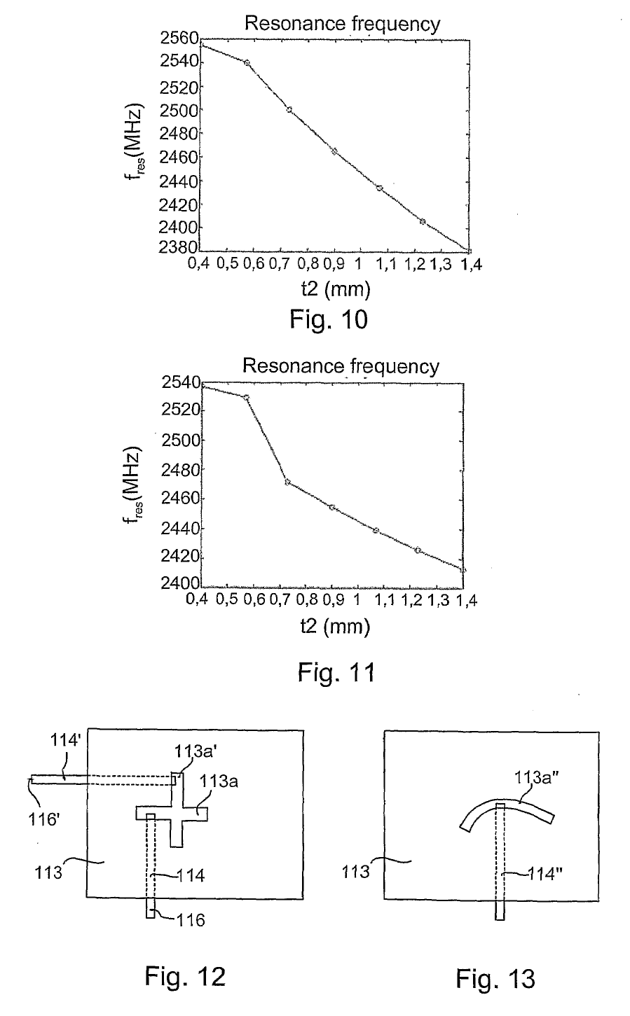

Yet another way of tuning the antenna device is to adjust the thickness of the dielectric layers 112 and 115. In FIG. 10 the resonance frequency of the antenna device is shown as a function of the thickness of the first dielectric layer 112 while in FIG. 11 the resonance frequency of the antenna device is shown as a function of the thickness of the second dielectric layer 115.

In FIGS. 8-11, tuning in the Bluetooth frequency band has been shown. In this embodiment, it would also be possible to provide an antenna device operating in frequency bands different from the Bluetooth frequency band, such as the GPS or GSM 1800 bands. Generally, the stacked patch antenna configuration provided by the second embodiment gives a wider bandwidth than conventional patch antennas.

The above described embodiments are adapted for operating with linearly polarized radio waves. Using the inventive concept, it would also be possible to provide an antenna device operating with circularly polarized radio waves. A third embodiment of an antenna device according to the invention operating with circularly polarized radio waves is shown in FIG. 12, wherein only micro strip lines and the slotted patch are shown. It is here assumed that also PCB, dielectric layer(s) etc. are provided.

In this third embodiment, two microstrip lines 114, 114′ are provided on the PCB. These two microstrip lines extend in directions essentially perpendicular to each other and are connected to a first and a second feeding point 116, 116′, respectively. These two feeding points are fed with identical but 90 degrees mutually phase displaced signals.

The single slot of the first and second embodiments has been replaced by a double slot, essentially comprising two slots 113, 113′ extending in mutually perpendicular directions. As can be seen in FIG. 12, the two slots together form a cross shaped opening.

As in the first and second embodiments, the first microstrip line 114 feeding the first slot 113a extends essentially perpendicularly to the direction of this first slot while the second microstrip line 114′ feeding the second slot 113a′ extends essentially perpendicularly to the direction of this second slot.

Tuning of this third embodiment is effected in a way corresponding to the way of tuning the second embodiment.

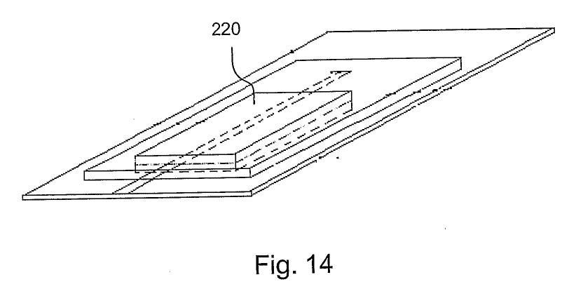

The slots of the above described embodiments have all been straight. In a fourth embodiment shown in FIG. 13, the slotted patch 113″ is provided with a curved slot 113a″, which is excited by a microstrip line 114″. This embodiment is in all other aspects similar to the above described embodiments.

The above described embodiments all show a battery package as part of an antenna. In an alternative embodiment shown in FIG. 14 the battery is replaced by a display package 220. The display package operates in all essential aspects as part of an antenna device like the above described battery packages.

Preferred embodiments of an antenna device according to the invention have been described. The person skilled in the art realizes that these could be varied within the scope of the appended claims.

Although a generally planar battery package has been shown, it can take other shapes as well. Thus, a possible shape is a slightly curved or bent battery package.

The electrically conductive battery housing has been described as extending on all sides of the battery package. It will be appreciated that the electrically conductive material of the battery housing can be limited to only some of the sides of the battery package.

The slotted patch has been described as a separate part. Alternatively, it could be provided integrated with a label cover provided on the battery package 120. It is also envisaged that the slotted patch is integrated in the battery holder.

The microstrip lines have been described as ending directly under the slot. It will be appreciated that the exact location of the ending point of the micro-strip line can vary but it must be in the close vicinity of the slot.

A detachable battery package has been described above. However, it is envisaged that in the future a battery has a life-time that is comparable with that of the rest of the portable radio communication device in which it is provided. This removes the need for a separate battery package. Instead the battery can be integrated in the housing of the radio communication device itself. This provides for an even more inexpensive device.

In the described embodiments, the battery has been shown as being rather thin, which in most cases is preferred when used in a portable radio communication device. However, it is realized that also an antenna device with a rather thick battery falls within the scope of protection as defined by the appended claims.

Only the antenna device according to the invention has been described. It will be appreciated that this antenna device can be used as a complementary antenna device and that there may be other antenna devices in the portable radio communication device.

Circular polarization has been described. It will be appreciated that the inventive idea is applicable to elliptical polarization as well, i.e., wherein the phase shift is different from zero degrees or multiples of 90 degrees.

Batteries with no connection to ground have been described. It will be appreciated that also antenna devices comprising a grounded battery are intended to fall within the scope of the appended claims. The resonance frequency will be slightly lower in case the battery is grounded, but the general function remains.

In the case the battery constitutes a problem with RF power induced into the rest of the communication device then a low pass filter could be provided in the connection to the battery.

Single band antennas have been described. Also multi-band antennas can be provided with the inventive concept if more than one feeding microstrip line are provided and the battery is correspondingly configured, e.g., with one slot for each microstrip line. These slots should be non-overlapping and preferably provided mutually perpendicular. In this case the width of the battery provides a first resonance frequency and the length of the battery a second resonance frequency.

Battery and display packages have been mentioned as possible parts of an antenna device according to the invention. It will be appreciated that also other parts of the portable radio communication device, such as covers, can be used in a similar way.

1. An antenna device for use in a portable radio communication device, comprising:
a ground plane (10; 110);
a microstrip line (14; 114; 114′; 114″) connected to a feed point (16; 116; 116′; 116″) for feeding and/or receiving radio frequency signals;
characterized by
a package (20; 120; 220) having an electrically conductive housing (22; 122);
wherein the housing is provided above the ground plane and the microstrip line;
wherein the housing is galvanically insulated from the microstrip line; and
wherein the housing is capacitively coupled to the microstrip line.

2. The antenna device according to claim 1, comprising a spacer (12; 112, 113, 115) provided between the microstrip line (14; 114; 114′; 114″) and the housing (22; 122).

3. The antenna device according to claim 1, comprising:
a slotted patch (113; 113′; 113″) provided between the microstrip line (114; 114′; 114″) and the housing (122), wherein the slotted patch is provided with a slot (113a; 113a′; 113a″),
a first dielectric layer (112) provided between the microstrip line and the slotted patch; and
a second dielectric layer (115) provided between the slotted patch and the housing.

4. The antenna device according to claim 3, wherein the slot is elongated having a length to width ratio of at least 3:1.

5. The antenna device according to claim 3, wherein the microstrip line (14; 114; 114′; 114″) runs essentially perpendicularly to the extension of the slot (113a; 113a′; 113a″).

6. The antenna device according to claim 3, wherein the end of the microstrip line (14; 114; 114′; 114″) is provided in the vicinity of the slot (113a; 113a′; 113a″).

7. The antenna device according to claim 1, wherein the package is integrated in the electrically conductive housing of the radio communication device.

8. The antenna device according to claim 3, wherein the slotted patch (113) is provided with a further slot (113a′), and comprising a further microstrip line (114′) connected to a feed point (114′) and running essentially perpendicularly to the extension of the further slot.

9. The antenna device according to claim 1, wherein the antenna device is operable in a frequency band selected from the group of frequency bands consisting of: the Bluetooth band, the WLAN band, or the GPS band.

10. The antenna device according to claim 1, wherein the package is a battery package.

11. The antenna device according to claim 1, wherein the package is a display package.

12. A portable radio communication device, comprising an antenna device according to claim 1.

13. A battery package (20; 120) for a portable radio communication device, said battery package comprising an electrically conductive battery housing (22; 122), characterized by
a slotted patch (13; 113; 113′; 113″) made of an electrically conductive material and having a slot (13a; 113a; 113a′; 113a″),
wherein the slot overlaps the electrically conductive battery housing.

14. The battery package according to claim 13, wherein the slotted patch is integrated with a label cover provided on the battery package (120).

15. The antenna device according to claim 3, wherein the slot is elongated having a length to width ratio of at least 5:1.

16. The antenna device according to claim 3, wherein the slot is elongated having a length to width ratio of at least 10:1.

17. The antenna device according to claim 3, wherein the slot is elongated having a length to width ratio of at least 20:1.

18. The antenna device according to claim 6, wherein the end of the microstrip line is provided directly under the slot.
